(19) United States
(12) Patent Application Publication
(10) Pub. No.: US 2012/0208091 A1
(43) Pub. Date: Aug. 16, 2012

(54) Polymer-Based Solid Electrolytes and Preparation Methods Thereof

(75) Inventors: Chung-Bo Tsai, New Taipei City (TW); Yan-Ru Chen, New Taipei City (TW); Wen-Hsien Ho, New Taipei City (TW); Kuo-Feng Chiu, New Taipei City (TW); Shih-Hsuan Su, New Taipei City (TW)

(73) Assignee: TAIWAN TEXTILE RESEARCH INSTITUTE, New Taipei City (TW)

(21) Appl. No.: 13/397,883

(22) Filed: Feb. 16, 2012

(30) Foreign Application Priority Data
Feb. 16, 2011 (TW) 100105123

(51) Int. Cl. H01M 10/056

(52) U.S. Cl. 429/307; 429/306; 429/311

(57) ABSTRACT

Polymer-based solid electrolytes and preparation methods thereof are provided. The polymer-based solid electrolyte comprises a polymer, an electrolyte, and a solvent. The polymer of the solid electrolyte can be polyvinyl alcohol (PVA) or sulfonated polyetheretherketone (SPEEK). The electrolyte is a lithium salt.

### CROSS-REFERENCE TO RELATED APPLICATION

This application claims the priority benefit of Taiwan application serial no. 100105123, filed Feb. 16, 2011, the full disclosure of which is incorporated herein by reference.

### BACKGROUND

1. Technical Field

The disclosure relates to an electrolyte and a preparation method thereof. More particularly, the disclosure relates to a solid electrolyte and a preparation method thereof.

2. Description of Related Art

Lithium secondary (rechargeable) batteries (abbreviated as lithium batteries below) have advantages of high working potential, high energy potential, light weight, and long life. Therefore, the lithium batteries have been widely applied on consumer electronics products and some high power products.

The electrolyte used in the lithium batteries can be divided into liquid electrolyte and solid electrolyte. Although the liquid electrolyte has higher ionic conductivity, the electrolyte is easily leaked, and thus a more complicated package is needed. Therefore, it is difficult to reduce the size of the lithium batteries using liquid electrolyte.

Comparing with the liquid electrolyte, the lithium batteries using solid electrolyte (also called as solid thin film batteries) do not need to worry about the leakage problem, and thus have higher safety. Furthermore, since the thickness of the solid thin film batteries is only 1-20 μm, the solid thin film batteries can be made into any sizes and shapes to meet various requirements. Moreover, the solid thin film batteries have high power density, can be charged and discharged for thousands times and in a high-temperature environment. Since the solid thin film batteries have the features above, the solid thin film batteries have been applied in products, such as IC card, flexible electronic devices, and biomedical applications, those need thin flexible power supply.

In the research of the solid electrolyte, the main goals still include increasing the energy density, the number of charge and discharge cycles, the mechanical strength, reliability, the thermal stability of the solid thin film batteries.

### SUMMARY

Accordingly, one aspect of this invention is to provide a polymer-based solid electrolyte that has a good tensile strength and a good ionic conductivity and a preparation method of the polymer-based solid electrolyte.

Therefore, a PVA-based solid electrolyte having a tensile strength of about 1.4-2.5 kgf/mm² and an ionic conductivity of about 10⁻⁶-10⁻² S/cm at room temperature is provided. The PVA-based solid electrolyte comprises a lithium salt, polyvinyl alcohol (PVA), and a solvent less than 50 wt % of the PVA-based solid electrolyte.

According to an embodiment, the lithium salt can be LiClO₄, LiBF₄, LiPF₆, LiAsF₆, LiCF₃SO₃, LiN(CF₃SO₃)₂, LiBr, or any combinations thereof.

According to another embodiment, the PVA has a molecular weight of about 20,000-186,000 Da.

According to yet another embodiment, a weight ratio of the lithium salt to the PVA is about 0.1-5.

According to yet another embodiment, the solvent contains water and ethanol, and a weight ratio of the ethanol to the water is at most 2.

A method of preparing the PVA-based solid electrolyte above is also provided. In this method, a PVA solution is prepared by dissolving polyvinyl alcohol (PVA) in a solvent containing water. Then, a lithium salt is dissolved in the PVA solution to form a PVA-based electrolyte solution. Next, the PVA-based electrolyte solution is coated on a substrate and then dried to form a PVA-based solid electrolyte layer on the substrate.

Another aspect of this invention is to provide a polymer-based solid electrolyte that has a small thermal change rate of conductivity and capacity to provide a stable conductivity and capacity over a wide temperature range.

Therefore, a SPEEK-based solid electrolyte is provided. The SPEEK-based solid electrolyte comprises a lithium salt, sulfonated polyetheretherketone (SPEEK), and a polar aprotic solvent.

According to an embodiment, the lithium salt can be LiClO₄, LiBF₄, LiPF₆, LiAsF₆, LiCF₃SO₃, LiN(CF₃SO₃)₂, LiBr, or any combinations thereof.

According to another embodiment, the SPEEK has a molecular weight of about 10,000-50,000 Da.

According to yet another embodiment, a weight ratio of the lithium salt to the SPEEK is at most 2.

According to yet another embodiment, the solvent comprises dimethyl sulfoxide, N-methylpyrrolidinone, dimethylformamide, dimethylacetamide, or any combinations thereof.

A method of preparing the SPEEK-based solid electrolyte above is also provided. In this method, a SPEEK solution is prepared by dissolving sulfonated polyetheretherketone (SPEEK) in a polar aprotic solvent. Then, a lithium salt is dissolved in the SPEEK solution to form a SPEEK-based electrolyte solution. Next, the SPEEK-based electrolyte solution is coated on a substrate and then dried to form a SPEEK-based solid electrolyte layer on the substrate.

According to an embodiment, the SPEEK-based solid electrolyte layer can further immersed in a liquid solution of a lithium salt for about 1-60 sec after the drying step to reduce the charge transfer resistance between the solid electrolyte and a contacting electrode, but also increase the mobility of ions in solid electrolyte. The solvent used in the liquid solution of the lithium salt can be water, ethylene carbonate (EC), ethyl methyl carbonate (EMC), dimethyl carbonate (DMC), or propylene carbonate (PC).

The foregoing presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

Many of the attendant features will be more readily appreciated as the same becomes better understood by reference to the following detailed description considered in connection with the accompanying drawings.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### PVA-Based Solid Electrolyte

In one aspect, this invention provides a polymer-based solid electrolyte that has a good tensile strength and a good ionic conductivity. Accordingly, a PVA-based solid electrolyte having a tensile strength of about 1.4-2.5 kgf/mm² and an ionic conductivity of about 10⁻⁶-10⁻² S/cm at room temperature is provided. The PVA-based solid electrolyte comprises a lithium salt, polyvinyl alcohol (PVA), and a solvent.

According to an embodiment, the lithium salt can be a lithium salt with lower lattice energy, such as LiClO₄, LiBF₄, LiPF₆, LiAsF₆, LiCF₃SO₃, LiN(CF₃SO₃)₂, LiBr, or any combinations thereof. A lithium salt with lower lattice energy can increase the ionic conductivity of the PVA-based solid electrolyte. Furthermore, the weight ratio of the lithium salt to the PVA is better to be at most 5, such as 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5. Generally, the ionic conductivity of the PVA-based solid electrolyte is higher when the lithium salt's content is higher. However, if the lithium salt's content is too high, white turbidities will occur in the PVA-based solid electrolyte, and a film of the PVA-based solid electrolyte can be uneven. This may be caused by destroying the PVA's crystallinity by the over high lithium salt's content therein.

According to another embodiment of this invention, the PVA's molecular weight is better to be 20,000-186,000 Da, such as 80,000-100,000 Da. Since PVA is a polymeric material, the above PVA's molecular weight can affect the formation condition, such as drying temperature and drying time, and the mechanical strength, such as tensile strength, of the PVA-based solid electrolyte.

According to yet another embodiment, the solvent contains water and ethanol. The weight ratio of the ethanol to the water is better to be at most 2, such as 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2.

The solvent content in the PVA-based solid electrolyte is determined by the application field, such as solid thin film batteries or supercapacitors, and the material to be used for electrodes of the application. For example, if solid thin film batteries using transitional metal oxide to be their electrode's material, the solvent content in the PVA-based solid electrolyte is better less than 30 wt %, such as less than 20 wt %. If the solid thin film batteries using zinc-manganese oxide to be their electrode's material, the solvent content in the PVA-based solid electrolyte is better to be 30-40 wt %. For supercapacitors, the needed solvent content is usually higher than the solid thin film batteries. Therefore, the solvent content in the PVA-based solid electrolyte is usually below 50 wt % for the supercapacitors. Of course, the solvent content of the PVA-based solid electrolyte is also affected by the material used for the electrodes of the supercapacitors. It should be understood that the solvent contents and application ways above are only used to explain the application ways of the PVA-based solid electrolyte, and not used to limit the scope of the claims in this invention.

### Preparation of PVA-Based Solid Electrolyte

The PVA-based solid electrolyte above can be prepared at a relatively low temperature (about 40-120° C.). By choosing a proper solvent to prepare a PVA-based electrolyte solution for forming the PVA-based solid electrolyte above, the formation time can be reduced to at most 48 hours. At the same time, the obtained PVA-based solid electrolyte can have good mechanical strength and good ionic conductivity.

Accordingly, the PVA-based solid electrolyte above can be prepared by the following steps. First, a PVA solution is prepared by dissolving polyvinyl alcohol (PVA) in a solvent containing water.

According to an embodiment, the PVA solution contains 5-20 wt % of PVA. The solvent above can be a mixture of water and ethanol. According to an embodiment, the weight ratio of the ethanol to the water can be at most 2, such as 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2.

According to another embodiment, the PVA solution can be prepared further by heating to increase the dissolving rate or the PVA in the solvent. For example, if the volume of the PVA solution is about 500 ml, the PVA solution can be heated at about 80° C. for about 2 hours to substantially dissolve the PVA therein.

Next, a lithium salt is dissolved in the PVA solution to form a PVA-based electrolyte solution. The added amount of the lithium salt can be 0.1-5 times of the added PVA's weight. For example, the weight ratio of the lithium salt to the PVA can be 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5.

According to an embodiment, the lithium salt can be directly added into the PVA solution to directly dissolve the lithium salt therein to form the PVA-based electrolyte solution. According to another embodiment, the lithium salt can be independently dissolved in a selected solvent, such as water, mixture of water and ethanol, dimethyl sulfoxide, N-methylpyrrolidinone etc., to obtain a lithium salt solution having a concentration of about 0.5-2 M. Then, the lithium salt's solution is mixed with the PVA solution to form the PVA-based electrolyte solution. During the mixing step above, the mixed solution can be further stirred, heated, or stirred and heated, to uniformly mix each component in the PVA-based electrolyte solution.

If the PVA-based electrolyte solution is prepared by a method including stirring, bubbles may be produced in the PVA-based electrolyte solution. Since the bubbles will affect the quality of the PVA-based solid electrolyte, the PVA-based electrolyte solution is better to stay for a period of time, such as 5-10 minutes to remove the bubbles therein.

Then, the PVA-based electrolyte solution is coated on a substrate and subsequently dried to form a PVA-based solid electrolyte layer on the substrate. The thickness of the PVA-based electrolyte solution on the substrate is better to be about 50-500 μm, such as 100-250 μm. The substrate above can be a rigid substrate, such as a stainless steel substrate, or a flexible substrate, such as a textile.

The drying temperature and time is usually determined by the solvent used for the PVA-based electrolyte solution and the needed solvent content of the finally obtained PVA-based solid electrolyte layer. Furthermore, the drying temperature and time can affect the mechanical strength and the ionic conductivity. Accordingly, the drying temperature above can be about 40-120° C., such as 60-100° C. For example, the PVA-based electrolyte solution can be dried at a temperature of 40, 45, 50, 55, 60, 65, 70, 75, 80, 85, 90, 75, 100, 105, 110, 115, or 120° C. The PVA-based electrolyte solution on the substrate can be dried by being put into an oven or a vacuum oven set at a temperature of about 40-120° C. However, this invention is not limited thereto.

The drying time above is better to be at most 48 hours, such as 2-24 hours. For example, the drying time can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, or 48 hours. Under the drying temperature above, it was found that the solvent content of the PVA-based solid electrolyte above can be reduced to about 50 wt %, or even less, within 48 hours. In fact, in some embodiments, only 3-5 hours of drying time is needed to reduce the solvent content of the PVA-based solid electrolyte to about 50 wt %.

### Preparation of Flexible Lithium Batteries

### Using PVA-Based Solid Electrolyte

In another aspect, a preparation method of flexible lithium batteries is provided. This preparation method of the flexible lithium batteries basically utilizes the preparation method of the PVA-based solid electrolyte to increase the related efficacy of the flexible lithium batteries.

After the preparation steps of the PVA-based electrolyte solution above, the PVA-based electrolyte solution can be respectively coated on both opposite surfaces of a flexible substrate. The coating method can be spray coating, knife coating, roller coating, spinning coating, dip coating, or curtain coating. The coating thickness of the PVA-based electrolyte solution is better to be about 50-500 μm, such as 100-250 μm.

Next, the flexible substrate and the two layers of PVA-based solid electrolyte are dried at a temperature of 40-120° C. for at most 48 hours to obtain PVA-based solid electrolyte layers having a solvent content smaller than 70 wt %. Since for taking care of the efficacy of the finally obtained flexible lithium batteries and the feasibility of the subsequent processes, the solvent content of the PVA-based solid electrolyte at this stage only needs to be reduced to less than about 70 wt %. In addition, the thickness of the obtained composite structure of the flexible substrate sandwiched by the two PVA-based solid electrolyte layers is about 100-1000 μm, such as about 200-500 μm.

The flexible substrate above can be a textile, such as a textile made of glass fibers to increase the mechanical strength of the composite structure of the flexible substrate sandwiched by the two PVA-based solid electrolyte layers, and thus the finally obtained flexible lithium batteries. In this instance, the flexible lithium batteries can be called as textile lithium batteries.

Next, a positive electrode layer and a negative electrode layer are respectively formed on the two opposite outer surfaces of the composite structure of the flexible substrate sandwiched by the two PVA-based solid electrolyte layers to obtain the flexible lithium battery. For example, the flexible lithium battery can be assembled by the following method, but this invention is not limited thereto.

In this method, a positive and a negative electrode layers can be independently formed by using suitable material. Then, the composite structure of the flexible substrate and the PVA-based solid electrolyte layers is sandwiched by the positive and the negative electrode layers. A thermopressing step is performed to combine each material layer to obtain a flexible lithium battery. During the thermopressing step, the solvent content of the PVA-based solid electrolyte layers will be further reduced by evaporating.

Moreover, the PVA-based solid electrolyte can be further used to prepare flexible capacitors. For example, a textile can also be used as the flexible substrate to obtain a composite structure of the flexible substrate and the PVA-based solid electrolyte layer. Then, the composite structure above can be used to form a textile capacitor.

For better understanding the preparation method and the properties of the PVA-based solid electrolyte, some experimental results are provided below.

### Experiment 1

### Solvent Effect on PVA Film

In this experiment, PVA (average molecular weight 88,000 Da) was dissolved in various solvents to obtain various 10 wt % PVA solutions. Next, each of the PVA solutions was coated on a substrate and then dried in a 60° C. vacuum oven to form a PVA film on the substrate. The conditions and results are listed in Table 1.

TABLE 1
Solvent effect on the PVA film

| | Solvent | | Solvent | Tensile |
|---|---|---|---|---|
| | Composition | | Content | Strength |
| | (EtOH/H₂O)* | Drying Time (hours) | (wt %) | (kgf/mm²) |
| Example 1-1 | 0 | 5 | 16.7 | 2.41 |
| Example 1-2 | 0.5 | 4 | 37.5 | 2.38 |
| Example 1-3 | 1.0 | 3 | 47.4 | 1.54 |
| Example 1-4 | 1.5 | 3 | 65.5 | 1.40 |
| Comparative | DMSO** | 39 | >50 | 1.62 |
| Example 1 | | | | |

*Weight ratio
**Dimethyl sulfoxide

From the results of Table 1, it can be known that the drying time of the PVA solutions using the solvent containing water was quite short, less than 5 hours. From the results of Examples 1-3 and 1-4, the needed drying time was longer when the ethanol content is greater. Contrarily, when the solvent of the PVA solution is DMSO, an organic solvent, the needed drying time of the PVA solution was greatly increased to 39 hours. In Examples 1-1 and 1-2 with greater water content, the tensile strength was greater than the Comparative Example 1.

Accordingly, using solvent containing water can decrease the needed drying time of the PVA solution and obtain a PVA film with greater tensile strength and the needed solvent content.

### Experiment 2

### Effect of Solvent Content on Ionic Conductivity

In this experiment, the solvent used was ethanol and water mixed in a weight ratio of 1:1. First, PVA (average molecular weight 88,000 Da) and LiClO₄ were respectively dissolved in the solvent above to form 10 wt % PVA solution and 2 M LiClO₄ solution. Then, 20 g of the PVA solution and 5 ml of the LiClO₄ solution were mixed to form a PVA-based electrolyte solution. The PVA-based electrolyte solution was coated on a substrate and then dried in a 60° C. vacuum oven to form a PVA-based solid electrolyte film on the substrate. The conditions and results are listed in Table 2.

TABLE 2
Effect of Solvent Content on Ionic Conductivity

| | | Solvent Content | Ionic Conductivity* |
|---|---|---|---|
| Example | Drying Time (hours) | (wt %) | (S/cm) |
| 2-1 | 5.0 | 42.47 | 8.94 × 10⁻³ |
| 2-2 | 6.5 | 28.10 | 4.11 × 10⁻³ |
| 2-3 | 8.0 | 17.73 | 7.28 × 10⁻⁵ |
| 2-4 | 23.5 | 15.05 | 1.87 × 10⁻⁵ |
| 2-5 | 25.0 | 12.17 | 1.96 × 10⁻⁵ |

*Ionic Conductivity = thickness/(resistivity × surface area), wherein resistivity was measured by resistivity analysis devices including Potentiostat/Galvanostat (Model 263 A) and Frequency Response Detector (Model FRD100) purchased from Princeton Applied Research.

From the results of Table 2, it can be known that solvent content was lower when the drying time was longer, and the ionic conductivity was decreased when the solvent content was decreased. The ionic conductivity could reach 10⁻³ S/cm when the solvent content was greater than 25 wt %.

### Experiment 3

### Effect of PVA's Molecular Weight on Ionic Conductivity

In this experiment, the solvent used was ethanol and water mixed in a weight ratio of 1:1. First, PVA with various molecular weights and LiClO₄ were respectively dissolved in the solvent above to form 10 wt % PVA solution and 2 M LiClO₄ solution. Then, 20 g of the PVA solution and 5 ml of the LiClO₄ solution were mixed to form various PVA-based electrolyte solutions. Each of the PVA-based electrolyte solution was coated on a substrate and then dried in a 60° C. vacuum oven for about 18 hours to form a PVA-based solid electrolyte film on the substrate. The conditions and results are listed in Table 3.

TABLE 3
Effect of PVA's Molecular Weight on Ionic Conductivity

| | | Solvent | | |
|---|---|---|---|---|
| | PVA's MA | Content | Ionic Conductivity* | Thickness |
| Example | (Da) | (%) | (S/cm) | (μm) |
| 3-1 | 20,000-30,000 | 9.10 | 9.54 × 10⁻⁶ | 150 |
| 3-2 | 88,000 | 8.30 | 5.06 × 10⁻⁶ | 200 |
| 3-3 | 146,000-186,000 | 5.83 | 3.13 × 10⁻⁶ | 200 |

*Ionic Conductivity = thickness/(resistivity × surface area), wherein resistivity was measured by resistivity analysis devices including Potentiostat/Galvanostat (Model 263 A) and Frequency Response Detector (Model FRD100) purchased from Princeton Applied Research.

From the results of Table 3, it can be known that the solvent content was decreased with the increase of the PVA's molecular weight when the drying temperature and the drying time were both keep at the same. Therefore, the ionic conductivity was also decreased with the increase of the PVA's molecular weight.

### Experiment 4

### Effect of Lithium Salt Content on Ionic Conductivity

In this experiment, the solvent used was ethanol and water mixed in a weight ratio of 1:1. First, PVA (average molecular weight 88,000 Da) and LiClO₄ were respectively dissolved in the solvent above to form 10 wt % PVA solution and 2 M LiClO₄ solution. Then, 20 g of the PVA solution and various volumes of the LiClO₄ solution were mixed to form various PVA-based electrolyte solutions. Each of the PVA-based electrolyte solution was coated on a substrate and then dried in a 60° C. vacuum oven for about 24 hours to form a PVA-based solid electrolyte film on the substrate. The conditions and results are listed in Table 4.

TABLE 4
Effect of Lithium Salt Content on Ionic Conductivity

| Example | LiClO₄/PVA (weight ratio) | Ionic Conductivity* (S/cm) |
|---|---|---|
| 4-1 | 0.1 | 5.50 × 10⁻⁶ |
| 4-2 | 0.2 | 1.68 × 10⁻⁵ |
| 4-3 | 0.4 | 3.18 × 10⁻⁵ |
| 4-4 | 0.6 | 4.60 × 10⁻⁵ |
| 4-5 | 1.0 | 3.30 × 10⁻⁴ |

*Ionic Conductivity = thickness/(resistivity × surface area), wherein resistivity was measured by resistivity analysis devices including Potentiostat/Galvanostat (Model 263 A) and Frequency Response Detector (Model FRD100) purchased from Princeton Applied Research.

From the results of Table 4, it can be known that the ionic conductivity was increased with the increase of the lithium salt content.

### SPEEK-Based Solid Electrolyte

In another aspect, this invention provides a polymer-based solid electrolyte that has a small thermal change rate of conductivity and capacity to provide a stable conductivity and capacity over a wide temperature range. Accordingly, a SPEEK-based solid electrolyte having a small thermal change rate of conductivity and capacity over a temperature range of 25-80° C. is provided below. The thermal change rate of the conductivity can be smaller than 80%, and the thermal change rate of the capacity can be smaller than 60%. The SPEEK-based solid electrolyte comprises a lithium salt, sulfonated polyetheretherketone (SPEEK), and a polar aprotic solvent.

According to an embodiment, the lithium salt can be a lithium salt with lower lattice energy, such as LiClO₄, LiBF₄, LiPF₆, LiAsF₆, LiCF₃SO₃, LiN(CF₃SO₃)₂, LiBr, or any combinations thereof. A lithium salt with lower lattice energy can increase the ionic conductivity of the SPEEK-based solid electrolyte. Furthermore, the concentration of the lithium salt in the SPEEK-based solid electrolyte is better to be at most 9.4 mmol/g, such as 1.6-4.7 mmol/g. Generally, the ionic conductivity of the SPEEK-based solid electrolyte is higher when the lithium salt's content is higher. However, if the lithium salt's content is too high, white turbidities will occur in the SPEEK-based solid electrolyte, and a film of the SPEEK-based solid electrolyte can be uneven. This may be caused by destroying the SPEEK's crystallinity by the over high lithium salt's content therein.

According to another embodiment of this invention, the SPEEK's molecular weight is better to be 10,000-50,000 Da, such as 20,000-30,000 Da. Since SPEEK is a polymeric material, the above SPEEK's molecular weight can affect the formation condition, such as drying temperature and drying time, and the mechanical strength, such as tensile strength, of the SPEEK-based solid electrolyte.

According to yet another embodiment, the content of the polar aprotic solvent is less than 40 wt %. The polar aprotic solvent can be dimethyl sulfoxide (DMSO), N-methylpyrrolidinone (NMP), dimethylformamide (DMF), dimethylacetamide (DMAc), or any combinations thereof.

### Preparation of SPEEK-Based Solid Electrolyte

The SPEEK-based solid electrolyte above can be prepared by the following steps. First, SPEEK can be prepared by sulfonating polyetheretherketone (PEEK). The sulfonating agent of the sulfonating reaction above can be sulfuric acid, for example. The sulfonating condition of the sulfonating reaction above can be performed at about 50° C. for about 12 hours, for example. An exemplary chemical structure of the obtained SPEEK is shown below.

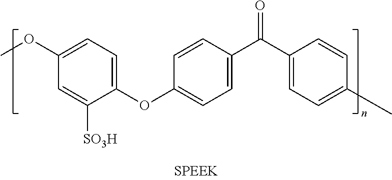

Then, a SPEEK solution is prepared by dissolving sulfonated polyetheretherketone (SPEEK) in a polar aprotic solvent. According to an embodiment, the SPEEK solution contains 1-12 wt % of SPEEK. The polar aprotic solvent can be DMSO dimethyl sulfoxide (DMSO), N-methyl pyrrolidinone (NMP), dimethylformamide (DMF), dimethylacetamide (DMAc), or any combinations thereof, for example.

According to another embodiment, the SPEEK solution can be prepared further by heating to increase the dissolving rate or the SPEEK in the polar aprotic solvent. For example, if the weight of the SPEEK solution is about 105 g (5 g SPEEK+100 g DMSO), the SPEEK solution can be heated at about 60° C. for about 2-4 hours to substantially dissolve the SPEEK therein.

Next, a lithium salt is dissolved in the SPEEK solution to form a SPEEK-based electrolyte solution. The added amount of the lithium salt can be at most 2 times of the added SPEEK's weight.

According to an embodiment, the lithium salt can be directly added into the SPEEK solution to directly dissolve the lithium salt therein to form the SPEEK-based electrolyte solution. During this step, the solution can be further stirred, heated, or stirred and heated, to uniformly mix each component in the SPEEK-based electrolyte solution. The heating temperature can be about 60° C. to 70% of the polar aprotic solvent's boiling point. If the heating temperature is too low, the solubility of the SPEEK in the polar aprotic solvent will be too low, and the viscosity of the SPEEK-based electrolyte solution will be too high to facilitate the subsequent coating step.

If the SPEEK-based electrolyte solution is prepared by a method including stirring, bubbles may be produced in the SPEEK-based electrolyte solution. Since the bubbles will affect the quality of the SPEEK-based solid electrolyte, the SPEEK-based electrolyte solution is better to stay for a period of time, such as 5-10 minutes to remove the bubbles therein.

Next, the SPEEK-based electrolyte solution is coated on a substrate and subsequently dried to form a SPEEK-based solid electrolyte layer on the substrate. The substrate above can be a rigid substrate, such as a stainless steel substrate, or a flexible substrate, such as a textile.

The drying temperature and time is usually determined by the solvent used for the SPEEK-based electrolyte solution and the needed solvent content of the finally obtained SPEEK-based solid electrolyte layer. Furthermore, the drying temperature and time can affect the mechanical strength and the ionic conductivity. Accordingly, the drying temperature above can be about 60-120° C., such as 60, 65, 70, 75, 80, 85, 90, 95, 100, 105, 110, 115, or 120° C. The drying time can be at most 72 hours.

Finally, the dried SPEEK-based solid electrolyte layer on the substrate can be further optionally immersed in a liquid solution of a lithium salt for about 1-60 sec after the drying step to reduce the charge transfer resistance between the solid electrolyte and a contacting electrode, but also increase the mobility of ions in solid electrolyte. The solvent used in the liquid solution of the lithium salt can be water, ethylene carbonate (EC), ethyl methyl carbonate (EMC), dimethyl carbonate (DMC), or propylene carbonate (PC). Then, the conductivity of the interface between the PVA-based solid electrolyte layer and an electrode can be further improved.

The lithium salt can be LiOH, LiNO₃, Li₂SO₄, LiClO₄, LiCF₃SO₃, LiN(CF₃SO₃)₂, or a combination thereof. The concentration of the lithium salt in the liquid solution is better to be at most 10 M.

### Preparation of Flexible Lithium Batteries

### Using SPEEK-Based Solid Electrolyte

In another aspect, a preparation method of flexible lithium batteries is provided. This preparation method of the flexible lithium batteries basically utilizes the preparation method of the SPEEK-based solid electrolyte to increase the related efficacy of the flexible lithium batteries.

After the preparation steps of the SPEEK-based electrolyte solution above, the SPEEK-based electrolyte solution can be respectively coated on both opposite surfaces of a flexible substrate. The coating method can be spray coating, knife coating, roller coating, spinning coating, dip coating, or curtain coating. Next, the flexible substrate and the two layers of SPEEK-based solid electrolyte are dried at a temperature of 60-120° C. for at most 72 hours to obtain SPEEK-based solid electrolyte layers.

The flexible substrate above can be a textile, such as a textile made of glass fibers to increase the mechanical strength of the composite structure of the flexible substrate sandwiched by the two SPEEK-based solid electrolyte layers, and thus the finally obtained flexible lithium batteries.

Next, a positive electrode layer and a negative electrode layer are respectively formed on the two opposite outer surfaces of the composite structure of the flexible substrate sandwiched by the two SPEEK-based solid electrolyte layers to obtain the flexible lithium battery. For example, the flexible lithium battery can be assembled by the following method, but this invention is not limited thereto.

In this method, a positive and a negative electrode layers can be independently formed by using suitable material. Then, the composite structure of the flexible substrate and the SPEEK-based solid electrolyte layers is sandwiched by the positive and the negative electrode layers. A thermopressing step is performed to combine each material layer to obtain a flexible lithium battery. During the thermopressing step, the solvent content of the SPEEK-based solid electrolyte layers will be further reduced by evaporating.

Moreover, the SPEEK-based solid electrolyte can be further used to prepare flexible capacitors. For example, a textile can also be used as the flexible substrate to obtain a composite structure of the flexible substrate and the SPEEK-based solid electrolyte layer. Then, the composite structure above can be used to form a textile capacitor.

For better understanding the preparation method and the properties of the SPEEK-based solid electrolyte, some experimental results are provided below.

### Experiment 5

### Effect of Lithium Salt Concentration to Ionic Conductivity

In this experiment, a SPEEK solution was prepared by adding 5 g of SPEEK into 100 g of DMSO, and then stirred at 60° C. to dissolve the SPEEK in the DMSO. Next, various amounts of LiClO₄ was added into the SPEEK solution to form SPEEK-based electrolyte solutions with various lithium salt concentration. Each of the SPEEK-based electrolyte solutions was then coated on a substrate and then dried at 60° C. to form SPEEK-based solid electrolyte on the substrate. Finally, the SPEEK-based solid electrolyte on the substrate was immersed in water for ______ sec. The conditions and results are listed in Table 5.

TABLE 5
Effect of Lithium Salt Concentration to Ionic Conductivity

| | Concentration of LiClO₄ | Ionic Conductivity* |
|---|---|---|
| Sample | (mmol/g) | (S/cm) |
| 5-1 | 0 | 6.21 × 10⁻³ |
| 5-2 | 1.6 | 9.40 × 10⁻³ |
| 5-3 | 2.7 | 12.63 × 10⁻³ |
| 5-4 | 3.5 | 16.04 × 10⁻³ |

*Ionic Conductivity = thickness/(resistivity × surface area), wherein resistivity was measured by resistivity analysis devices including Potentiostat/Galvanostat (Model 263 A) and Frequency Response Detector (Model FRD100) purchased from Princeton Applied Research.

From the results of Table 5, it can be known that the ionic conductivity was increased with the increase of the lithium salt content.

### Experiment 6

### Analysis of Thermal Change Rate of Conductivity and Capacity

In Examples 6-1 to 6-3 of this experiment, a SPEEK solution was prepared by adding 5 g of SPEEK into 100 g of DMSO, and then stirred at 60° C. to dissolve the SPEEK in the DMSO. Next, various amounts of LiClO₄ was added into the SPEEK solution to form SPEEK-based electrolyte solutions with various lithium salt concentration. Each of the SPEEK-based electrolyte solutions was then coated on a substrate and then dried at 60° C. to form SPEEK-based solid electrolyte on the substrate. Then, each of the SPEEK-based solid electrolyte was immersed various immersing liquids for about 10 seconds. In Comparative Examples 6-1 and 6-2, PVA and polyethylene oxide (PEO) were used to replace SPEEK. The conditions and results are listed in Table 6.

TABLE 6
Analysis of Thermal Change Rate of Conductivity and Capacity

| | Polymer-Based | | Thermal Change Rate | |
|---|---|---|---|---|
| | Solid | Immersing | (%) over 25-80° C. | |
| | Electrolyte | Liquid | ¹Conductivity | ²Capacity |
| Example 6-1 | SPEEK-LiClO₄ | Water | 77.9 | 38.7 |
| Example 6-2 | | 3M LiOH_{(aq)} | 27.2 | 55.3 |
| Example 6-3 | | 3M | 15.0 | 16.4 |
| | | LiNO_{3(aq)} | | |
| Comparative | PVA-LiClO₄ | Water | 429.5 | 334.1 |
| Example 6-1 | | | | |
| Comparative | ³PEO-LiClO₄ | — | 32,400 | — |
| Example 6-2 | | | | |

¹Calculated by (σ_{80° C.} − σ_{25° C.})/σ_{25° C.} × 100
²Calculated by (C_{80° C.} − C_{25° C.})/C_{25° C.} × 100
³From FIG. 2 of Materials Science and Engineering, B107 (2004), pp 244-250.

From the results of Table 6, it can be known that the thermal change rate of the conductivity and capacity for the SPEEK-based solid electrolytes is the smallest among the three different kinds of polymers (SPEEK, PVA, and PEO). In Examples 6-1 to 6-3, the various immersing liquids also affect the thermal change rate of the conductivity and capacity. The most amazing one is SPEEK-LiClO₄ immersed in LiNO_{3(aq)}, which has only a thermal change rate of 15.0% for conductivity and 16.4% for capacity.

Accordingly, the PVA- and SPEEK-based solid electrolytes provided above have various good properties. Moreover, the PVA and SPEEK-based solid electrolytes can be integrated into the textile batteries and the textile capacitors described above. The combination of the textile batteries and the textile capacitors described above can be applied on livelihood textiles, such as clothes and furnishings, and industry textiles, such as clothes used outdoors, wisdom textiles. The combination of the textile batteries and the textile capacitors described above can even be applied on flexible displays, consumer electronic products, and biomedical applications. Therefore, the textile batteries and the textile capacitors above are quite innovative.

All the features disclosed in this specification (including any accompanying claims, abstract, and drawings) may be replaced by alternative features serving the same, equivalent or similar purpose, unless expressly stated otherwise. Thus, each feature disclosed is one example only of a generic series of equivalent or similar features.

What is claimed is:

1. A preparation method of a PVA-based solid electrolyte, comprising:
preparing a PVA solution by dissolving polyvinyl alcohol (PVA) in a solvent containing water;
dissolving a lithium salt in the PVA solution to form a PVA-based electrolyte solution;
coating the PVA-based electrolyte solution on a substrate; and
drying the PVA-based electrolyte solution to form a PVA-based solid electrolyte layer on the substrate.

2. The preparation method of claim 1, wherein the solvent further comprises ethanol, and the weight ratio of the ethanol to the water is at most 2.

3. The preparation method of claim 1, wherein the molecular weight of the PVA is about 20,000-186,000 Da.

4. The preparation method of claim 1, wherein the lithium salt is LiClO₄, LiBF₄, LiPF₆, LiAsF₆, LiCF₃SO₃, LiN(CF₃SO₃)₂, LiBr, or any combinations thereof.

5. The preparation method of claim 1, wherein a weight ratio of the lithium salt to the PVA is 0.1-5 in the PVA-based electrolyte solution.

6. The preparation method of claim 1, wherein the PVA-based electrolyte solution is dried at a temperature of about 40-120° C. for at most 48 hours, and the PVA-based solid electrolyte comprises at most 50 wt % of the solvent.

7. The preparation method of claim 1, wherein the substrate is a flexible substrate.

8. The preparation method of claim 7, further comprising forming two electrode layers respectively on opposite outer surfaces of the PVA-based solid electrolyte layer on the substrate.

9. A PVA-based solid electrolyte having a tensile strength of about 1.4-2.5 kgf/mm² and an ionic conductivity of about 10⁻⁶-10⁻² S/cm at room temperature, the PVA-based solid electrolyte comprising:
a lithium salt being selected from a group consisting of LiClO₄, LiBF₄, LiPF₆, LiAsF₆, LiCF₃SO₃, LiN(CF₃SO₃)₂, LiBr, and any combinations thereof;
polyvinyl alcohol (PVA) having a molecular weight of about 20,000-186,000 Da, wherein a weight ratio of the lithium salt to the PVA is at most 5; and
a solvent less than 50 wt %, wherein the solvent contains water and ethanol, and a weight ratio of the ethanol to the water is at most 2.

10. A preparation method of a SPEEK-based solid electrolyte, comprising:
preparing a SPEEK solution by dissolving sulfonated polyetheretherketone (SPEEK) in a polar aprotic solvent;
dissolving a lithium salt in the SPEEK solution to form a SPEEK-based electrolyte solution;
coating the SPEEK-based electrolyte solution on a substrate; and
drying the SPEEK-based electrolyte solution to form a SPEEK-based solid electrolyte layer on the substrate.

11. The preparation method of claim 10, wherein the polar aprotic solvent comprises dimethyl sulfoxide, N-methylpyrrolidinone, dimethylformamide, dimethylacetamide, or any combinations thereof.

12. The preparation method of claim 10, wherein the molecular weight of the sulfonated polyetheretherketone is 10,000-50,000 Da.

13. The preparation method of claim 10, wherein the lithium salt is LiClO₄, LiBF₄, LiPF₆, LiAsF₆, LiCF₃SO₃, LiN(CF₃SO₃)₂, LiBr, or any combinations thereof.

14. The preparation method of claim 10, wherein a weight ratio of the lithium salt to the SPEEK is at most 2 in the SPEEK-based electrolyte solution.

15. The preparation method of claim 10, wherein the SPEEK-based electrolyte solution is dried at a temperature of about 60-120° C. for at most 72 hours, and a solvent content of the SPEEK-based solid electrolyte is smaller than 40 wt %.

16. The preparation method of claim 10, further comprising immersing the SPEEK-based solid electrolyte layer in a liquid solution of a lithium salt for about 1-60 sec after the drying step to reduce the charge transfer resistance between the solid electrolyte and an electrode and increase the mobility of ions in solid electrolyte.

17. The preparation method of claim 16, wherein the lithium salt is LiOH LiNO₃, Li₂SO₄, LiClO₄, LiCF₃SO₃, or LiN(CF₃SO₃)₂.

18. The preparation method of claim 17, further comprising forming two electrode layers respectively on opposite outer surfaces of the SPEEK-based solid electrolyte layer on the substrate.

19. A SPEEK-based solid electrolyte having conductivity's thermal change rate smaller than 80% and capacity's thermal change rate smaller than 60%, comprising:
a lithium salt being selected from a group consisting of LiClO₄, LiBF₄, LiPF₆, LiAsF₆, LiCF₃SO₃, LiN(CF₃SO₃)₂, LiBr, and any combinations thereof;
sulfonated polyetheretherketone (SPEEK) having a molecular weight of about 10,000-50,000 Da, wherein a weight ratio of the lithium salt to the SPEEK is at most 2; and
a polar aprotic solvent, wherein a content of the solvent is less than 40 wt %.

20. The SPEEK-based solid electrolyte of claim 19, wherein the polar aprotic solvent comprises dimethyl sulfoxide, N-methylpyrrolidinone, Dimethylformamide, Dimethylacetamide, or any combinations thereof.
